(19) United States
(12) Patent Application Publication
(10) Pub. No.: US 2008/0057848 A1
(43) Pub. Date: Mar. 6, 2008

(54) Venturi gate valve assembly for an auxiliary power unit

(75) Inventors: Rick S. Gray, Phoenix, AZ (US); Eric J. Shepard, Phoenix, AZ (US); Cecilia S. Lam, Scottsdale, AZ (US); Yogendra Y. Sheoran, Scottsdale, AZ (US); Norman J. Hahn, Mesa, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/515,120

(22) Filed: Aug. 31, 2006

(51) Int. Cl. B60H 1/00

(52) U.S. Cl. 454/69

(57) ABSTRACT

A venturi gate valve assembly for extraction of bleed air flow from an auxiliary power unit (APU) and an APU compartment including the venturi gate valve assembly. The venturi gate valve assembly is configured to isolate and restrict bleed air flow from the APU via an extraction conduit. The venturi gate valve assembly includes an upstream valve flange, a throat area, a moveable valve gate, and a downstream valve flange, in fluid communication defining a bleed air flow path. A conical shaped diffuser is defined along the bleed air flow path from the throat area to the downstream flange.

### TECHNICAL FIELD

The present invention relates to aircraft auxiliary power units (APUs) and bleed air flow, more particularly, to an inline valve that provides restriction and isolation of the APU bleed air flow.

### BACKGROUND

In many aircraft, the main propulsion engines not only provide propulsion for the aircraft, but may also be used to drive various other rotating components such as, for example, generators, compressors, and pumps, to thereby supply electrical and/or pneumatic power. However, when an aircraft is on the ground, its main engines may not be operating. Moreover, in some instances the main propulsion engines may not be capable of supplying the power needed for propulsion as well as the power to drive these other rotating components. Thus, many aircraft include an auxiliary power unit (APU) to supplement the main propulsion engines in providing electrical and/or pneumatic power. An APU may also be used to start the propulsion engines.

An APU is, in most instances, a gas turbine engine that includes a combustion system, a power turbine, and a compressor. During operation of the APU, the compressor draws in ambient air, compresses it, and supplies compressed air to the combustion system. The combustion system receives fuel from a fuel source and the compressed air from the compressor, and supplies high-energy combusted air to the power turbine, causing it to rotate. The power turbine includes a shaft that may be used to drive a generator for supplying electrical power, and to drive its own compressor and/or an external load compressor.

Passenger aircraft are typically equipped with an environmental control system, including an air cycle conditioning system for cooling the aircrew cabins, and other aircraft locations and components. Typically, APUs and associated cooling systems are mounted in a compartment in the aft section of the aircraft, at or near the aircraft tailcone section. One class of air cycle conditioning systems that are widely used in aircraft takes advantage of a supply of pressurized air that is extracted, or bled, from an aircraft engine, known as bleed air. During operation it may be desired to limit the bleed air extraction to APU exhaust gas temperature. It may also be necessary to have a valve in line to isolate the APU airflow from the rest of the aircraft and provide control of the airflow on demand. In many APU designs, a venturi structure allows for airflow restriction, while a gate valve design allows for airflow isolation. More specifically, the venturi structure is used for flow measurement and flow limiting and typically has good flow recovery to maintain low loss. The user chooses the venturi throat diameter based on the maximum flow rate to be limited. The gate valve serves as an on-off valve that allows flow there through or shuts off the flow. These two structures are typically formed in series as separate devices along a bleed air extraction line.

Although the above-described configuration is generally safe, robust, and reliable, it does suffer certain drawbacks. For example, space near the APU is often limited. The use of a gate valve and a venturi structure along a bleed air extraction conduit, as separate and distinct devices formed in series is often prohibited due to space limitations. Furthermore, although separate and individually operable, when used in series to achieve both airflow restriction and airflow isolation of the bleed air extraction, such a configuration can undesirably increase overall system weight and cost.

Hence, there is a need for an inline valve that provides restriction and isolation of the flow of the APU bleed air that utilizes less space and does not undesirably increase overall system weight. There is a further need for such a system to include fewer components in order to reduce manufacturing cost.

### BRIEF SUMMARY

The present invention provides a venturi gate valve comprising: a flow body including an upstream valve flange, a downstream valve flange, and a bleed air flow path. The upstream valve flange defines an inlet. The downstream valve flange defines an outlet. The bleed air flow path extending, and providing fluid communication, between the inlet and the outlet. The bleed air flow path defines a throat area and a conical shaped diffuser downstream thereof. The throat area having a length (lₜₕ) and a diameter (dₜₕ). The valve further comprising a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed.

In one embodiment, and by way of example only, disclosed is a venturi gate valve assembly for an auxiliary power unit (“APU”) disposed in an aircraft. The valve assembly comprising: a flow body including an upstream valve flange, a downstream valve flange, and a bleed air flow path. The upstream valve flange defines an inlet. The downstream valve flange defines an outlet. The bleed air flow path extending, and providing fluid communication, between the inlet and the outlet. The bleed air flow path defines a throat area and a conical shaped diffuser downstream thereof. The throat area having a length (lₜₕ) and a diameter (dₜₕ). The valve further includes a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed. A duct diffuser coupled to the downstream valve flange.

In yet another embodiment, and by way of example only, disclosed is an auxiliary power unit (APU) compartment including a venturi gate valve for extraction of bleed air flow. The embodiment comprising: an APU compartment having a ram air inlet opening formed therein, the ram air inlet opening configured to receive a flow of ram air; an APU intake duct mounted within the APU compartment and having an inlet in fluid communication with the ram air inlet opening; a compressor mounted within the APU compartment and having an inlet in fluid communication with the APU intake duct, the compressor configured to increase a temperature of the flow of ram air and supply compressed air to at least a bleed air outlet port; an extraction conduit in fluid communication with the bleed air outlet port to receive a bleed air flow; a venturi gate valve positioned within the extraction conduit and configured to at least one of isolate and restrict the bleed air flow. The venturi gate valve comprising: a flow body including an upstream valve flange, a downstream valve flange, and a bleed air flow path. The upstream valve flange defining an inlet. The downstream valve flange defining an outlet. The bleed air flow path extending, and providing fluid communication, between the inlet and the outlet. The bleed air flow path defining a throat area and a conical shaped diffuser downstream thereof. The throat area having a length (lₜₕ) and a diameter (dₜₕ). The valve further comprising: a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed.

Other independent features and advantages of the venturi gate valve assembly for an auxiliary power unit will become apparent from the following detailed description, taken in conjunction with the accompanying drawings which illustrate, by way of example, the principles of the invention.

### BRIEF DESCRIPTION OF THE DRAWINGS

FIG. 1 is a simplified schematic representation of a portion of an aircraft depicting an auxiliary power unit (APU) compartment and various devices and support systems in the APU compartment;

FIG. 2 is a simplified cross section diagram of an APU that may be mounted in the APU compartment of FIG. 1;

FIG. 3 is a simplified cross section diagram of venturi gate valve that may be mounted in the APU compartment of FIG. 1;

FIG. 4 is a simplified cross section diagram of a venturi gate valve coupled to a tapered duct diffuser that may be mounted in the APU compartment of FIG. 1, according to a first embodiment of the invention; and

FIG. 5 a simplified cross section diagram of a venturi gate valve coupled to a duct that may be mounted in the APU compartment of FIG. 1, according to a second embodiment of the invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

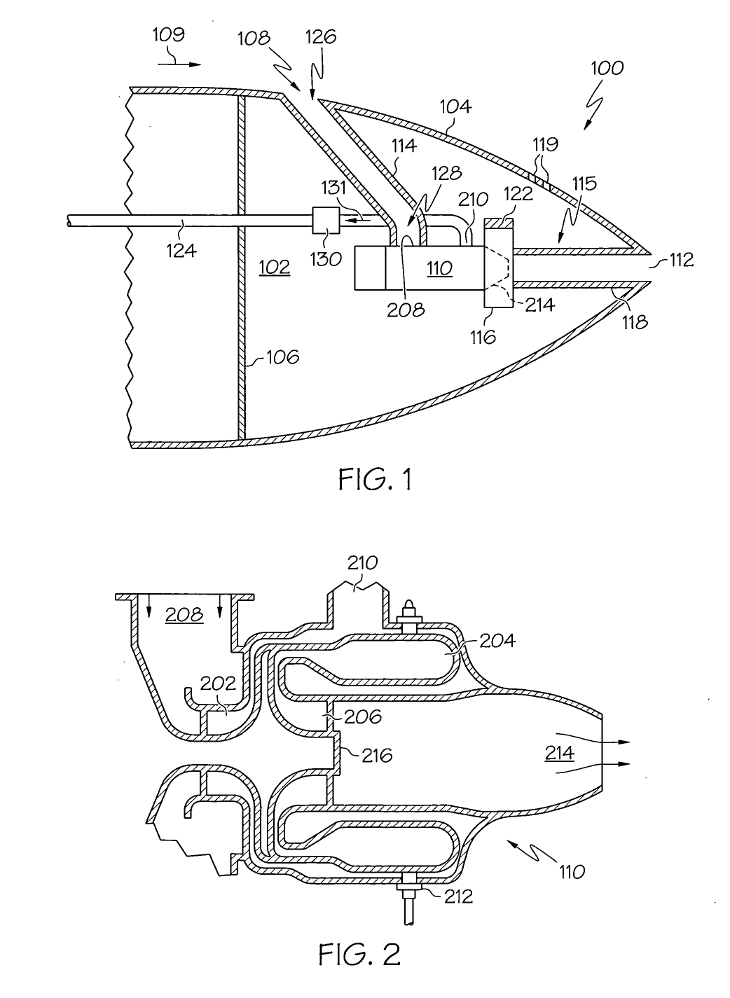

Turning now to FIG. 1, a cross-sectional schematic of a portion of an aircraft 100 is depicted. The aircraft 100 includes an auxiliary power unit (APU) compartment 102 that is defined by an exterior surface 104 and a firewall 106. As is generally known, the firewall 106 separates the APU compartment 102 from other sections of the aircraft 100. In the depicted embodiment, the APU compartment 102 is formed in the tailcone section of the aircraft 100. It will be appreciated, however, that this is merely exemplary, and that the APU compartment 102 could be formed in any one of numerous other sections of the aircraft 100. It will additionally be appreciated that, depending on its location in the aircraft 100, the APU compartment 102 may be defined by more than one firewall 106.

No matter its specific location, the APU compartment 102 includes one or more ram air inlet openings 108, and an exhaust opening 112. As will be described in more detail further below, the one or more ram air inlet openings 108 are configured to selectively receive ram air flow 109, and the exhaust opening 112 provides a point of egress from the APU compartment 102 for APU exhaust and other gasses. As will also be described further below, the ram air flow 109 is supplied to the compartment 102, for cooling purposes, and to an APU 110 that is mounted within the compartment. Before proceeding further, and for completeness, a brief description of an exemplary APU 110 that may be mounted within the compartment 102 will be provided.

With reference now to FIG. 2, an exemplary embodiment of the APU 110 is depicted. The exemplary APU 110 includes a compressor 202, a combustor 204, and a turbine 206. Air is directed into the compressor 202 via an air inlet 208. The compressor 202 raises the pressure of the air and supplies compressed air to both the combustor 204 and, in the depicted embodiment, to a bleed air outlet port 210. In the combustor 204, the compressed air is mixed with fuel that is supplied to the combustor 204 from a non-illustrated fuel source via a plurality of fuel nozzles 212. The fuel/air mixture is combusted, generating high-energy gas, which is then directed into the turbine 206.

The high-energy gas expands through the turbine 206, where it gives up much of its energy and causes the turbine 206 to rotate. The gas is then exhausted from the APU 110 via an exhaust gas outlet nozzle 214. As the turbine 206 rotates, it drives, via a turbine shaft 216, various types of equipment that may be mounted in, or coupled to, the APU 110. For example, in the depicted embodiment the turbine 206 drives the compressor 202. It will be appreciated that the turbine 206 may also be used to drive a generator and/or a load compressor and/or other rotational equipment, which are not shown in FIG. 2 for ease of illustration.

Returning once again to FIG. 1, it is seen that the APU 110, and more specifically the APU compressor inlet 208, is coupled to an APU intake duct 114. It is additionally seen that the APU 110, and more specifically the exhaust gas outlet nozzle 214, is coupled to an exhaust system 115. The APU intake duct 114 is coupled to selectively receive the ram air flow 109. The exhaust system 115, at least in the depicted embodiment, includes an eductor 116 and an outlet duct 118. The eductor 116 may be variously configured, but in the depicted embodiment it preferably surrounds, and receives the gas that is exhausted from, the exhaust gas outlet nozzle 214. It will be appreciated that in other embodiments, the exhaust gas outlet nozzle 214 may communicate with the eductor 116 via one or more intermediate components such as, for example, a mixer. Nonetheless, the eductor 116 is additionally configured, upon receipt of the exhaust gas, to draw compartment cooling air that is selectively supplied to the APU compartment 102 through, for example, an oil cooler 122 that is coupled to the eductor 116, and into the exhaust duct 118, which is coupled to, and in fluid communication with, the exhaust opening 112. In addition, outside air is drawn into the APU compartment 102 for cooling through at least one opening 119.

As was mentioned above, the APU intake duct 114 is coupled to selectively receive the ram air flow 109. To do so, the APU intake duct 114 includes an inlet 126 that is coupled to selectively receive the ram air flow 109, and an outlet 128 that is coupled to the APU compressor inlet 208.

During operation, compressed air is supplied to the bleed air outlet port 210 (FIG. 2). The bleed air 131 flows from the bleed air outlet port 210 through an extraction conduit 124. The extraction conduit 124 includes an inline valve 130 that controls the flow of the bleed air 131. This control of bleed air 131 extraction prevents the APU 110 from exceeding the maximum exhaust gas temperature limits.

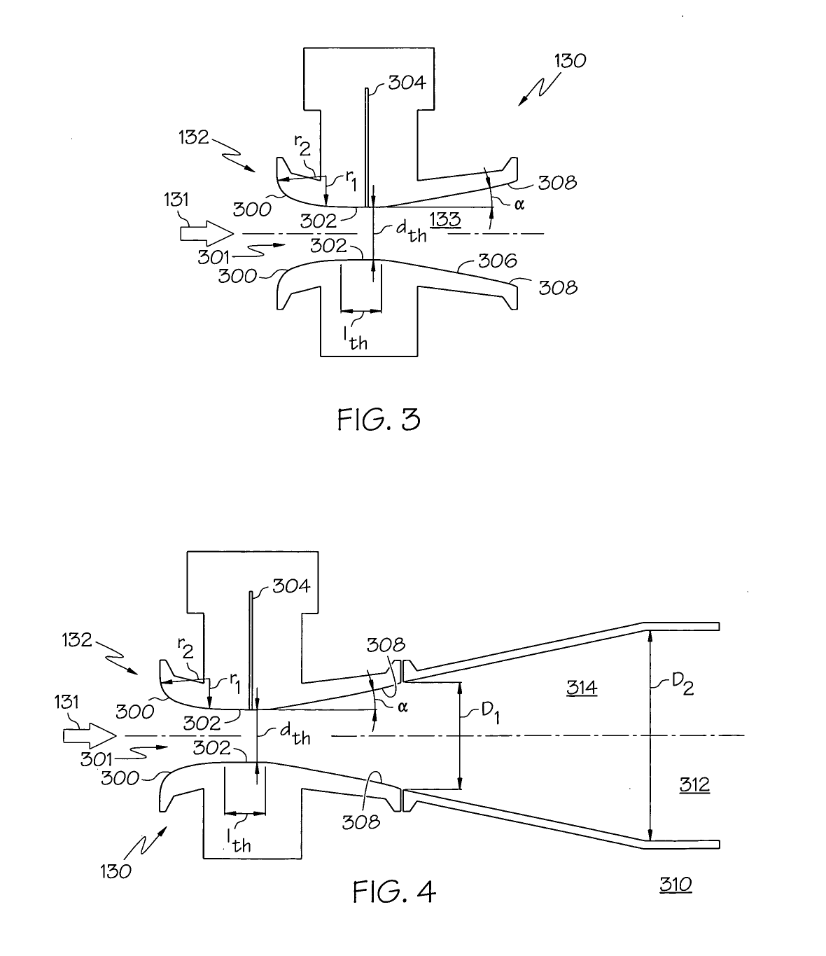

With reference now to FIG. 3, an embodiment of the inline valve 130 is depicted in which a flow body 132 of the valve 130 provides restriction and isolation of the APU bleed air 131 flowing through the extraction conduit 124. In general, the flow body 132 of the valve 130 serves as a flow limiter and restrictor for the flow of bleed air 131, while a downstream diffusion feature functions as an efficient venturi. The valve 130 combines the features of a typical gate valve and a flow limiting venturi structure into a single device, referred to herein as a venturi gate valve, having a bleed air flow path 133 defined therein. In this particular embodiment, the flow body 132 is preferably formed of a stainless steel material, although other materials such as aluminum or titanium may be used.

Referring still to FIG. 3, the valve 130 is comprised of an upstream valve flange 300 that defines an inlet 301 having a generally circular arc geometry, a throat area 302 having a diameter dₜₕ, and a downstream valve flange 308 that defines an outlet 309. The preferred geometry of the upstream valve flange 300, and more particularly the circular arc, is a 2:1 ellipse. This geometry allows the bleed air 131 flowing through the extraction conduit 124 to be streamlined into the throat area 302 of the valve 130 with minimal losses. Alternative geometries for the upstream valve flange 300 that would provide streamlined flow of the bleed air 131 are anticipated by this disclosure. As previously stated, in the preferred embodiment, the geometry of the circular arc of the upstream valve flange 300 is an ellipse wherein r₁ is a major axis, r₂ is a minor axis, r₁ is substantially equivalent to a diameter of the throat area 302, referenced dₜₕ, and r₂ is substantially equivalent to ½ of r₁.

The throat area 302 has a substantially constant length, lₜₕ, and serves as a flow limiter. The diameter of the throat area 302, dₜₕ, is sized based on the desired flow limitation of the bleed air 131. In a preferred embodiment, the length of the throat area 302 is substantially equivalent to ⅓ of the throat diameter, dₜₕ.

A valve gate 304 is positioned approximately midway in the throat area 302. The valve gate 304 operates as a typical gate valve element and provides isolation of the bleed air 131 in the valve 130. More specifically, the valve gate 304 is positionable between a closed position, in which the valve gate 304 at least substantially seals the valve inlet 301 and valve outlet 309, and an open position (as illustrated), in which the valve gate 304 unseals the bleed air flow path 133. It should be understood that the valve gate 304 is moveable to a partially open or fully open position (as illustrated) to allow bleed air 131 to flow through the inline valve 130.

A conical shaped valve diffuser 306 is defined along a length of the flow path 133 from the throat area 302 to the downstream valve flange 308. The geometry of the conical shaped diffuser 306 is set by a diffusion half angle, referenced α, of approximately 3.5° from a flow path centerline, shown in dotted line. This diffusion half angle minimizes flow separation and maximize pressure recovery in valve 130. The valve diffuser 306 is formed relatively short in length in that a downstream duct (described presently) may be formed to continue the same angle as the valve diffuser 306 until the diameter of the downstream duct is reached.

With reference now to FIG. 4, a valve assembly 310, in which the valve 130 is coupled to a duct 312 is illustrated. More specifically, the valve assembly 310 includes the downstream valve flange 308 coupled to a duct diffuser 314 to blend between the downstream valve flange 308, having a valve exit diameter D₁, and the duct 312, having a diameter D₂. To configure the valve assembly 310, a user would typically select the venturi gate valve 130 described herein, having a throat diameter, dₜₕ and an exit diameter D₁, that provides the necessary flow limitation matched to the users desired upstream flow condition. The duct 312 would typically have a diameter D₂ that is larger than the diameter D₁ of the upstream valve flange 308 exit for overall low system pressure loss. This approach configures the valve assembly 310 to additionally be used as a flow metering device. By measuring the static pressure in the throat area 302, and knowing the upstream flow pressure and temperature, the flow rate can be calculated, thereby utilizing the flow metering function of the valve 130.

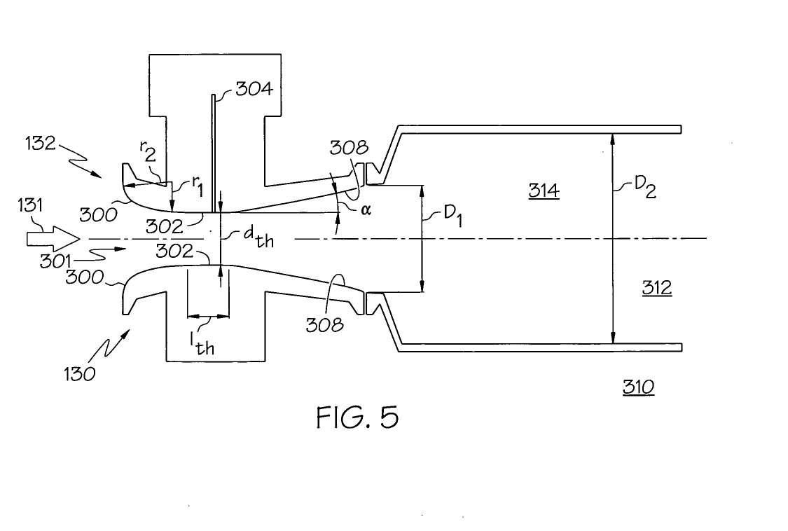

In an alternative embodiment, when a user is only interested in the isolation and flow limiting function of the venturi gate valve 130, the downstream valve flange 308 of the venturi gate valve 130 can dump directly into to the full size duct 312. More specifically, as illustrated in FIG. 5, the venturi gate valve 130 is coupled to the duct 312 without the use of a diffuser as in the previous embodiment to blend the diameter D₁ of the downstream valve flange 308 with the diameter D₂ of the duct 312. In this embodiment, there is no separate tapered diffuser as in the previous embodiment where the valve downstream flange 308 connects to the duct 312. The venturi gate valve 130 is configured to “dump” directly to the duct 312.

No matter the specific coupling configuration of the valve assembly 310, the venturi gate valve 130 provides bleed air 131 flow isolation and flow restriction in a single device thus utilizing minimum space requirements. In the closed position, the valve gate 304 at least substantially, but preferably completely, seals the throat area 302. As a result, the flow of the bleed air 131 is at least substantially inhibited, and preferably prevented, from entering the duct 312. In the open position, illustrated in FIGS. 3-5, the valve gate 304 unseals the throat area 302, thereby allowing the bleed air 131 to enter the venturi valve diffuser 306 and 314. Assembly 310 acts as a flow limiting structure, flow measuring structure, and provides engine temperature control with minimal pressure losses.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A venturi gate valve comprising:
a flow body including an upstream valve flange, a downstream valve flange, and a bleed air flow path, the upstream valve flange defining an inlet, the downstream valve flange defining an outlet, the bleed air flow path extending, and providing fluid communication, between the inlet and the outlet, the bleed air flow path defining a throat area and a conical shaped diffuser downstream thereof, the throat area having a length (lₜₕ) and a diameter (dₜₕ); and
a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed.

2. The valve of claim 1, wherein the upstream valve flange has a circular arc geometrical shape.

3. The valve of claim 1, wherein the upstream valve flange has a elliptical shape wherein a dimension r₁ is a major axis, a dimension r₂ is a minor axis, wherein r₁ is substantially equal to dₜₕ, and r₂ is substantially equal to ½ of r₁.

4. The valve of claim 1, wherein lₜₕ is substantially equal to ⅓ of dₜₕ.

5. The valve of claim 1, wherein the moveable valve gate is positioned midway lₜₕ.

6. The valve of claim 1, wherein the flow body is comprised of stainless steel.

7. The valve of claim 1, wherein the conical shaped diffuser has a diffusion half angle of 3.5° from a centerline of the bleed air flow path.

8. A venturi gate valve assembly for an auxiliary power unit (“APU”) disposed in an aircraft, the valve assembly comprising:
a flow body including an upstream valve flange, a downstream valve flange, and a bleed air flow path, the upstream valve flange defining an inlet, the downstream valve flange defining an outlet, the bleed air flow path extending, and providing fluid communication, between the inlet and the outlet, the bleed air flow path defining a throat area and a conical shaped diffuser downstream thereof, the throat area having a length (lₜₕ) and a diameter (dₜₕ);
a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed; and
a duct diffuser coupled to the downstream valve flange.

9. The valve assembly of claim 8, wherein the upstream valve flange has a elliptical shape wherein a dimension r₁ is a major axis, a dimension r₂ is a minor axis, r₁ is substantially equal to dₜₕ, and r₂ is substantially equal to ½ of r₁.

10. The valve assembly of claim 8, wherein lₜₕ is substantially equal to ⅓ of dₜₕ.

11. The valve assembly of claim 8, wherein the moveable valve gate is positioned midway the length lₜₕ.

12. The valve of claim 8, wherein the flow body is comprised of stainless steel.

13. The valve assembly of claim 8, wherein the conical shaped diffuser has a diffusion half angle of 3.5° from a centerline of the bleed air flow path.

14. The valve assembly of claim 7, wherein the downstream valve flange has an exit dimension D₁, the duct diffuser has a dimension D₂, and D₂ is greater than D₁.

15. An auxiliary power unit (APU) compartment including a venturi gate valve for extraction of bleed air flow comprising:
an APU compartment having a ram air inlet opening formed therein, the ram air inlet opening configured to receive a flow of ram air;
an APU intake duct mounted within the APU compartment and having an inlet in fluid communication with the ram air inlet opening;
a compressor mounted within the APU compartment and having an inlet in fluid communication with the APU intake duct, the compressor configured to increase a temperature of the flow of ram air and supply compressed air to at least a bleed air outlet port;
an extraction conduit in fluid communication with the bleed air outlet port to receive a bleed air flow;
a venturi gate valve positioned within the extraction conduit and configured to at least one of isolate and restrict the bleed air flow, the venturi gate valve comprising:
a flow body including an upstream valve flange, a downstream valve flange, and a bleed air flow path, the upstream valve flange defining an inlet, the downstream valve flange defining an outlet, the bleed air flow path extending, and providing fluid communication, between the inlet and the outlet, the bleed air flow path defining a throat area and a conical shaped diffuser downstream thereof, the throat area having a length (lₜₕ) and a diameter (dₜₕ); and
a valve gate mounted on the flow body and movable between a closed position, in which the valve gate extends substantially completely across the throat area and flow through the bleed air flow path is at least substantially prevented, and an open position, in which the valve gate does not extend substantially completely across the throat area and flow through the bleed air flow path is allowed.

16. The device of claim 15, further including a duct diffuser coupled to the downstream valve flange.

17. The device of claim 15, wherein the upstream valve flange has a elliptical shape wherein a dimension r₁ is a major axis, a dimension r₂ is a minor axis, wherein r₁ is substantially equal to dₜₕ, and r₂ is substantially equal to ½ of r₁.

18. The device of claim 15, wherein lₜₕ is substantially equal to ⅓ of dₜₕ.

19. The device of claim 15, wherein the conical shaped diffuser has a diffusion half angle of 3.5° from a centerline of the bleed air flow path.

20. The valve assembly of claim 7, wherein the downstream valve flange has an exit dimension D₁, the duct diffuser has a dimension D₂, and D₂ is greater than D₁.
